(19) United States
(12) Patent Application Publication
(10) Pub. No.: US 2026/0029040 A1
(43) Pub. Date: Jan. 29, 2026

(54) Power Transmission System

(71) Applicant: Means Industries, Inc., Saginaw, MI (US)

(72) Inventors: David King, Freeland, MI (US); Brice A. Pawley, Midland, MI (US)

(73) Assignee: Means Industries, Inc., Saginaw, MI (US)

(21) Appl. No.: 19/266,681

(22) Filed: Jul. 11, 2025

Related U.S. Application Data
(60) Provisional application No. 63/674,364, filed on Jul. 23, 2024.

(51) Int. Cl. F16H 3/64; F16H 3/58

(52) U.S. Cl. CPC F16H 3/64; F16H 3/58; F16H 2200/0021; F16H 2200/0034; F16H 2200/0039; F16H 2200/2007; F16H 2200/2084; F16H 2200/2087

(57) ABSTRACT

A power transmission system includes a simple planetary gearset and a compound planetary gearset. A first coupling mechanism associated with the simple planetary gearset selectively couples a component of the simple planetary gearset to ground, and a second coupling mechanism associated with the compound planetary gearset selectively couples a component of the compound planetary gearset to ground.

### CROSS-REFERENCE TO RELATED APPLICATIONS

This application claims the benefit of U.S. Provisional Application No. 63/674,364, filed on Jul. 23, 2024. The disclosure of the above application is incorporated herein by reference.

### BACKGROUND OF THE INVENTION

### 1. Field of the Invention

The invention generally relates to a vehicle power train or drive system and, more specifically, a drive system using a gearset.

### 2. Description of Related Art

Vehicle powertrains or drive systems typically incorporate multiple clutch elements. Existing powertrains, including ones using electric motors, are typically of concentric and/or parallel axis architectures; however, other architectures could also be used.

In the field of automotive technology, motor vehicle drive trains using electric motors and planetary drive trains include controllable or selectable coupling assemblies, for example, one-way clutches. These coupling assemblies can be electromagnetically operated and magnetically controlled.

These one-way clutches often include first and second members and at least one locking element (e.g., a strut, a pawl, etc.). The locking element moves between a deployed position, wherein the locking element extends from the first member and engages the second member, and a nondeployed position, wherein the locking element does not extend from the first member. Thereby, the first and second members are disengaged from each other.

Examples of one-way clutches can be found in U.S. Pat. No. 5,927,455, a bi-directional overrunning pawl-type clutch; U.S. Pat. No. 6,244,965 a planar overrunning coupling; and U.S. Pat. No. 6,290,044, a selectable one-way clutch assembly for use in an automatic transmission. U.S. Pat. Nos. 7,258,214 and 7,344,010 disclose overrunning coupling assemblies and U.S. Pat. No. 7,484,605 discloses an overrunning radial coupling assembly or clutch. The disclosures of each are hereby incorporated by reference. The foregoing is not exclusive; other selective or one-way clutches may be used and are known. The foregoing are examples of one-way clutches that may be used in a vehicle powertrain or drive system.

### SUMMARY OF THE INVENTION

A power transmission system includes a simple planetary gearset, and a compound planetary gearset. The system also includes a first coupling mechanism associated with the simple planetary gearset and a second coupling mechanism associated with the compound planetary gearset. The first coupling mechanism selectively couples a component of the simple planetary gearset to ground, and the second coupling mechanism selectively couples a component of the compound planetary gearset to ground.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic cross-sectional side view illustration of one example of a gearset of a multi-speed power transmission system.

FIGS. 2A-2D are lever diagrams of the gearset shown in FIG. 1.

FIG. 3 is a schematic cross-sectional side view illustration of another example of a gearset of a multi-speed power transmission system.

FIG. 4 is a schematic cross-sectional side view illustration of yet another example of a gearset of a multi-speed power transmission system.

FIGS. 5A-5E are lever diagrams of the gearset shown in FIGS. 3 and 4.

FIG. 6 is a schematic cross-sectional side view illustration of the gearset of FIG. 3 illustrating a power or torque path in 1^{st} gear.

FIG. 7 is a schematic cross-sectional side view illustration of the gearset of FIG. 3 illustrating a power or torque path in 2^{nd} gear.

FIG. 8 is a schematic cross-sectional side view illustration of the gearset of FIG. 4 illustrating a power or torque path in 3^{rd} gear.

FIGS. 9A and 9B are partial views showing multiple examples of a simple planetary gearset.

FIG. 10 is a partial view of an example of a compound planetary gearset.

### DETAILED DESCRIPTION OF THE PREFERRED EMBODIMENTS

The following description of the preferred embodiment(s) is merely exemplary in nature and is in no way intended to limit the invention, its application, or its uses.

Examples of the present invention are disclosed herein; however, it is to be understood that the disclosed embodiments are merely exemplary of the invention that may be embodied in various and alternative forms. The figures are not necessarily to scale; some features may be exaggerated or minimized to show details of the components. Therefore, specific structural and functional details disclosed herein are not to be interpreted as limiting but merely as a representative basis for teaching one skilled in the art to variously employ the present invention.

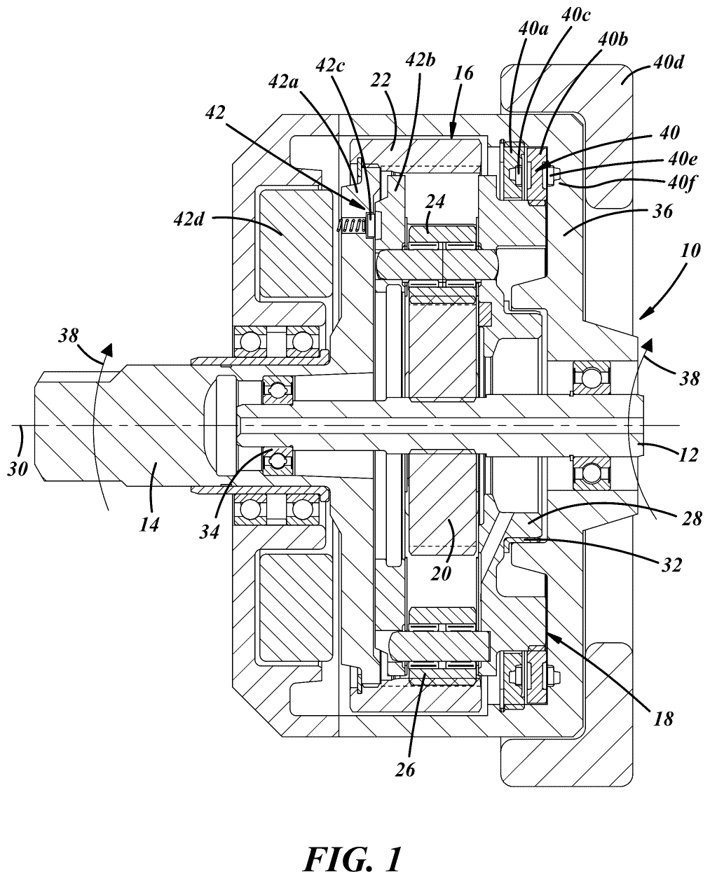

FIG. 1 schematically illustrates a power transmission system or drive assembly, generally seen at 10, according to one example of the present invention. The power transmission system or drive assembly 10 typically includes an input or drive member 12, for example, an electric or traction motor, and an output or driven member 14, for example, an output shaft connected to a vehicle wheel. The power transmission system or drive assembly 10 may incorporate multiple elements connecting or coupling the input or drive member 12 to the output or driven member 14. For example, it may include electric or traction motors, planetary drive trains, and layshaft drive trains, of both concentric and/or parallel axis configurations.

In one example, the power transmission system or drive assembly 10 includes a gear system or gearset, seen generally at 16. The term gear system or gearset broadly refers to a gear mechanism for transmitting motion and, in one example, includes a set of gears forming a group.

FIG. 1 schematically illustrates one example of a gearset 16 suitable for use with the power transmission system or drive assembly 10. The gearset 16 includes a compound epicyclic or planetary gearset, seen generally at 18. An electric motor (not shown) drives the input or drive member 12. The input or drive member 12 is coupled to the planetary gearset 18. The planetary gearset 18 includes a sun gear 20, a ring gear 22, and meshed inner and outer planet gears 24, 26 between the sun gear 20 and the ring gear 22. A planet carrier 28 holds the inner and outer planet gears 24, 26 at different radii from the centerline or rotational axis 30 of the sun gear 20 while allowing the individual inner and outer planet gears 24, 26 to rotate with respect to each other. The inner planet gear 24 meshes with the sun gear 20, and the outer planet gear 26 meshes with the ring gear 22. Because it contains inner and outer planet gears 24, 26, the double pinion planetary gearset 18, as opposed to a single pinion planetary gearset, the carrier 28 rotates in the same sense of direction as the sun 20. The ring gear 22 is coupled with or joined to the output or driven member 14.

The planet carrier 28 is rotatably supported on a stationary component or ground 36 by a bearing or bushing 32 and rotates independently of the input or drive member 12 and the sun gear 20. A bearing 34 rotatably supports the ring gear 22 and output or driven member 14 on the input or drive member 12, wherein the ring gear 22 rotates independently of the input or drive member 12 and the sun gear 20 and drives the output or driven member 14.

FIG. 1 schematically illustrates one example of the power transmission system or drive assembly 10 as a 2-speed transmission. As illustrated, the output or driven member 14 connects to the ring gear 22, with the output or driven member 14 rotating in the same direction, for example, clockwise, as shown by arrow 38, as the input or drive member 12. The power transmission system or drive assembly 10 includes a first coupling assembly or mechanism, generally seen at 40, that couples or connects the planet carrier 28 to ground 36. The first coupling assembly or mechanism 40 includes at least one one-way clutch, preferably two one-way clutches, that couple/connect the planet carrier 28 to ground 36—each one-way clutch coupling/connecting the planet carrier 28 to ground in one direction of rotation. Ground 36, as used herein, is a stationary component, for example, a casing, housing, or other component that does not move relative to the components of the planetary gearset 18.

In one example, the coupling assembly or mechanism 40 includes a passive one-way clutch or passive strut assembly. One example of a passive one-way clutch includes a fixed member, i.e., a first coupling member in the form of a “pocket plate,” and a rotating member, i.e., a second coupling member in the form of a “notch plate.” The pocket plate 40a is fixedly connected to a stationary component, for example, a transmission case, i.e., ground 36. The notch plate 40b is mounted to a member, for example, the planet carrier 28, for rotation relative to a pocket plate or ground 36 about the rotational axis 30. While the pocket plate is typically the fixed member, in some instances, to control coupling assembly or mechanism 40 dynamics, the pocket plate is, connects to, or forms part of the rotating member, and the notch plate is, connects to, or forms part of the stationary member.

The passive one-way clutch or passive strut assembly includes a passive or uncontrolled locking element 40c, for example, a strut, disposed in the pocket of the pocket plate. The one-way clutch is passive because the strut is not controlled. A resilient member or spring continuously biases the strut outward of the pocket in the pocket plate and past a side face or surface of the first coupling member. The resilient member or spring constantly urges the strut out of the pocket to a deployed position, wherein the strut extends out of the pocket in the first coupling member or pocket plate. In the deployed position, the struts may engage the second coupling member, for example, engage a notch in the notch plate or may overrun the second coupling member, for example, pass over the notches in the notch plate. The one-way clutch prevents rotation of the second coupling member or notch plate in one direction of rotation and allows overrun; that is, the second coupling member or notch plate rotates freely in the opposite direction. It passively controls torque in one direction and overruns in the opposite direction.

In another example, the coupling assembly or mechanism 40 includes a selectable or controllable one-way clutch; the state of the one-way clutch, activated or deactivated-deployed or nondeployed, can be selected or controlled. A selectable or controllable one-way clutch may also be referred to as an active one-way clutch. A selectable or controllable one-way clutch in a nondeployed condition allows overrun, freewheels in both directions and functions like a passive one-way clutch when deployed. Hence, a selectable or controllable one-way clutch is active, the state of the locking element, deployed or nondeployed, can be controlled, and passive in that the locking element, when deployed can be overrun. The term controllable mechanical diode clutch (CMD) refers to a controllable or selectable one-way clutch acting between a stationary and a rotating component. The term dynamically controllable clutch (DCC) refers to a controllable or selectable one-way clutch acting between two rotating components.

A selectable or controllable one-way clutch produces a mechanical connection between rotating or stationary components in one direction and can overrun in one or both directions. A selectable or controllable one-way clutch may include locking elements 40e combined with an actuator and/or selector mechanism, seen generally at 40d. The selector mechanism is operative to control the deployment of the locking element 40e located in pocket plate 40f. When deployed the locking element selectively mechanically couples the associated components. For example, a selectable or controllable one-way clutch is active in that the strut in the pocket plate may move between a nondeployed position—the strut in the pocket of the pocket plate and a deployed position—the strut extending outwardly from the pocket of the pocket plate and beyond or past the face or side surface of the pocket plate. In the deployed position, the locking element may engage the second coupling member or notch plate, wherein the one-way clutch passively locks in one direction of rotation and freely rotates or overruns in the opposite direction. The locking elements, actuator, and/or selector add multiple functions to the one-way clutch, including implementing the different operating modes.

In the present example, the first coupling assembly or mechanism 40 includes a pair of one-way clutches, each operable to engage/disengage and connect/disconnect the planet carrier 28 and ground 36 in opposite directions of rotation. A first one-way clutch includes locking elements or struts operable to engage/disengage and connect/disconnect the planet carrier 28 and ground 36 in one direction of rotation, for example, clockwise. The second one-way clutch includes locking elements or struts operable to engage/disengage and connect/disconnect the planet carrier 28 and ground 36 in the opposite direction of rotation, for example, counterclockwise. The first coupling assembly or mechanism 40 uses two one-way clutches to transmit torque in both directions of rotation. The first and second one-way clutches of the first coupling assembly or mechanism 40 enable both forward and reverse torque, wherein the first one-way clutch controls torque transfer in a direction of rotation, and the second one-way clutch controls torque transfer in a second direction of rotation. For example, the first direction of rotation, clockwise, corresponds to forward drive torque, and the second direction of rotation, counterclockwise, corresponds to reverse drive torque.

FIG. 1 illustrates a first example of the planetary gearset 18 wherein the output or driven member 14 rotates in the same direction of rotation as the input or drive member 12. In 1^{st} forward gear, the first one-way clutch of the first coupling assembly or mechanism 40 couples or connects the planet carrier 28 to ground 36, wherein the planet carrier 28 is fixed to ground 36 in at least one direction of rotation. Coupling or connecting the planet carrier 28 to ground 36 provides a first gear ratio or gear reduction proportional to the number of teeth on the ring gear 22 divided by the number of teeth in the sun gear 20.

In 1^{st} forward gear, torque is applied through the input shaft or drive member 12 from the motor to the sun gear 20 of the planetary gearset 18 in, for example, a clockwise direction. A one-way clutch of the first coupling assembly or mechanism 40 reacts torque by preventing motion of the planet carrier 28 in the counterclockwise direction, enabling a driven output in the same direction as the drive input. Preventing motion of the carrier 28 in the counterclockwise direction applies torque to the ring gear 22 in the clockwise direction.

In one example, the first one-way clutch of the first coupling assembly or mechanism 40 associated with the 1^{st} forward gear is passive, the locking element or strut, and correspondingly, at least part of the coupling assembly or mechanism 40, is always biased in the deployed direction. The passive first one-way clutch reacts torque in one direction, couples the planet carrier 28 and ground 36 when the planet carrier 28 rotates in one direction, and overruns, allowing the planet carrier 28 to rotate freely with respect to ground 36 when the planet carrier 28 rotates in the opposite direction. The first one-way clutch overruns in one direction and passively disconnects the planet carrier 28 and ground 36. The coupling assembly or mechanism 40 passively controls an operating mode of the power transmission system or drive assembly 10. In a passive operating mode, the planet carrier 28 is coupled to the stationary member or ground 36 whenever the planet carrier 28 rotates in one direction, and the planet carrier 28 rotates freely with respect to the stationary member or ground 36 in the other. Passive engagement of the system allows power to be sent through the system in one direction, for example, a forward direction, without the need for controls; for example, actuation systems or mechanisms used to deploy or control the position of the locking element or strut.

The second one-way clutch of the coupling assembly or mechanism 40 is a selectable or controllable one-way clutch movable from a deployed to a nondeployed position. When deployed, the second one-way clutch of the coupling assembly or mechanism 40 reacts torque in the opposite or second direction of rotation and couples the planet carrier 28 to the stationary member or ground 36, preventing rotation in the opposite or second direction. The coupling assembly or mechanism 40 actively controls an operating mode of the power transmission system or drive assembly 10, wherein in an operating mode, the planet carrier 28 is coupled to the stationary member or ground 36 in the opposite direction of rotation, for example, the reverse direction. Activating or engaging the second, selectable or controllable one-way clutch of the coupling assembly or mechanism 40 of the drive assembly 10 allows power to be sent through the system in the opposite direction, providing, for example, a 1^{st} reverse gear.

For example, a motor input in the counterclockwise direction provides a reverse gear mode. The locking element 40e of the second one-way clutch of the first coupling assembly or mechanism 40 reacts torque by preventing motion of the planet carrier 28 but in the opposite direction as when in 1^{st} forward gear. Therefore, motion of the planet carrier 28 is prevented by the first coupling assembly or mechanism 40 in the clockwise direction. The clockwise direction one-way clutch is an actively controlled passive clutch. The locking element moves from a nondeployed to a deployed position, placed into a passive mode, by an actuation system interacting with control elements within the first coupling assembly or mechanism 40.

While the coupling assembly or mechanism 40 includes two one-way clutches, a first one-way clutch for forward motion and a second one-way clutch for reverse motion, the first one-way clutch of the coupling assembly or mechanism 40, typically associated with 1^{st} forward gear, can be passive, with the second one way-clutch being selectable or controllable. While the first one-way clutch is passive, both the first and second one-way clutch may be selectable or controllable.

In addition to providing reverse gear or motion, the second one-way clutch of the coupling assembly or mechanism 40 can be used for regeneration in 1^{st} forward gear. The same one-way clutch that reacts torque during reverse also provides reaction torque during a regenerative braking condition in 1^{st} gear, thus enabling energy transfer from the vehicle back through the transmission into the motor, now operating as a generator, and into the battery.

In the disclosed example, the coupling assembly or mechanism 40 includes a first or passive one-way clutch and a second or selectable or controllable one-way clutch. Each one-way clutch acts on the planet carrier 28 to provide a power path and transfer torque from the input or drive member 12 to the output or driven member 14. The locking element 40c of the first or passive one-way clutch is always deployed wherein torque is always transferred from the input or drive member 12 to the output or driven member 14 when the input or drive member 12 rotates in a first direction, for example, a clockwise direction. The second or selectable or controllable one-way clutch is deployed to transfer torque from the input or drive member 12 to the output or driven member 14 when the input or drive member 12 rotates in the second or opposite direction, for example, a counterclockwise direction. In one example, clockwise rotation of the input or drive member 12 is associated with wheel or vehicle movement in a forward direction and counterclockwise rotation of the input or drive member 12 is associated with wheel or vehicle movement in a reverse direction.

Because the first one-way clutch is passive, the first coupling assembly or mechanism 40 saves the attendant costs. It eliminates the need for an additional actuation system to control the first one-way clutch.

FIG. 1 also illustrates an example of the planetary gearset 18 including a 2^{nd} gear, for example, a direct drive or 1:1, in the same direction of rotation as the input or drive member 12. In the 2^{nd} gear, the first coupling assembly or mechanism 40 either passively or actively decouples or disconnects the planet carrier 28 from ground 36, wherein the planet carrier 28 rotates freely with respect to the stationary member or ground 36. In one example, the power transmission system or drive assembly 10 includes a second coupling assembly or mechanism, generally seen at 42, that selectively couples or connects the ring gear 22 to the planet carrier 28. The second coupling assembly or mechanism 42 includes a selectable or controllable one-way clutch, for example, a dynamically controllable clutch having a pocket plate 42a, a notch plate 42b, and deployable locking elements 42c positioned in the pocket plate 42a. An actuator or selector mechanism, seen generally at 42d, operative to control the deployment of the locking element 42c, wherein the state of the clutch, activated or deactivated, can be selected or controlled. In the present example, parts of the actuation system 42d may or may not be tied to ground. The controllable or selectable one-way clutch of the second coupling assembly or mechanism 42 acts between two rotating components; for example, between the planet carrier 28 and the ring gear 22, the sun gear 20 and the ring gear 22, or the sun gear 20 and the planet carrier 28. By coupling the planet carrier 28 and the ring gear 22, the sun gear 20 to the ring gear 22, or the planet carrier 28 to the sun gear 20, the respective components rotate together, producing a direct drive or 1:1 ratio between the input or drive member 12 and the output or driven member 14.

The actuator or selector mechanism 40d, 42d of the first or second coupling assembly or mechanism 40, 42 may be positioned either radially or axially. The actuator or selector mechanism 40d, 42d could be a solenoid, lead screw, cam, or other mechanism used to actuate a locking element of a one-way clutch. Wherein the strut or locking element engages a selector plate, spring, pin, rod, or other force transmitting mechanism. Additional examples of actuation systems include a linear motor, a cam actuator, or other mechanism acting on the spring or the force transmitting member. Various actuation systems may be used, depending on whether both components rotate, or one is stationary and the other rotates.

In its base form, the power transmission system or drive assembly 10 shown in FIG. 1 includes a first coupling assembly or mechanism 40 with a passive one-way clutch and a second coupling assembly or mechanism 42 with a first selectable or controllable one-way clutch. This provides a two-speed power transmission system in one direction, for example, a forward direction. Depending upon a need for power transmission in the opposite direction, for example, a reverse direction, additional one-way clutches are added. To obtain motion in a reverse direction in 1^{st} gear only, the first coupling assembly or mechanism 40 needs a second one-way clutch, for example, a selectable or controllable one-way clutch controlling torque transfer in the opposite direction of rotation. To obtain motion in the reverse direction in 2^{nd} gear only, the first coupling assembly or mechanism 40 needs a selectable or controllable one-way clutch, and the second coupling assembly or mechanism 42 needs a selectable or controllable one-way clutch. In an example wherein reverse is provided in only 1^{st} gear, the first coupling assembly or mechanism 40 includes a second one-way clutch, and the second coupling assembly or mechanism 42 needs only the first one-way clutch.

Selectively coupling or decoupling portions of the planetary gearset 18 with each other or to ground 36 controls the power transmission system or drive assembly 10 direction and output.

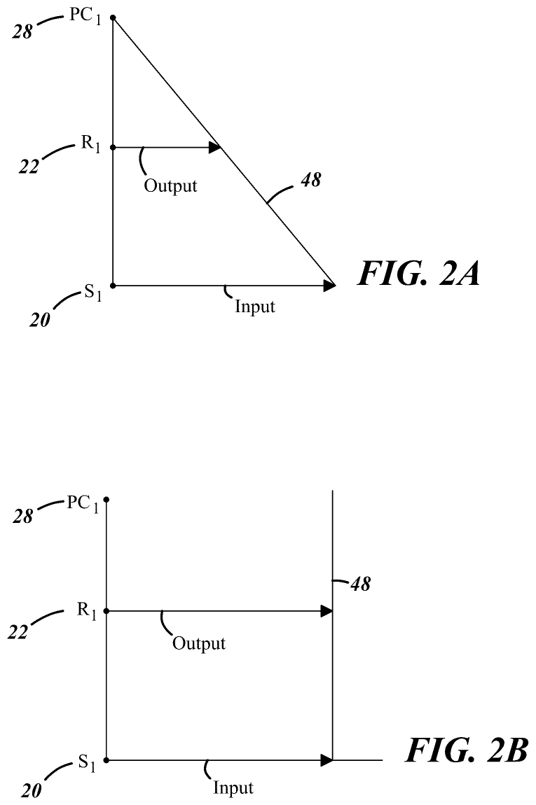

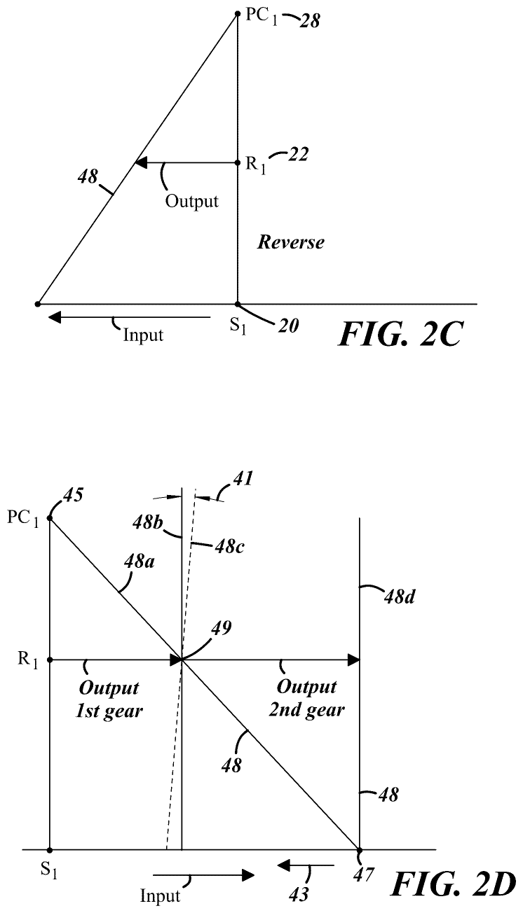

FIGS. 2A-2D show lever diagrams for the gear system or gearset 16 shown in FIG. 1. The nodes or points labeled R₁, PC₁, and S₁ of the lever diagram are points of application of forces or torques analogous to the ring gear, planet carrier, and sun gear, respectively.

Lever diagram, FIG. 2A shows the power transmission system or drive assembly 10 output at the output or driven member 14 when the drive assembly 10 is in a 1^{st} forward gear. The lever diagram of FIG. 2A shows the input moving one end of the lever 48 to the right, based on the input of the sun gear 20 at node S₁ with the lever 48 pivoting about the planet carrier 28 at node PC₁ and the output generated at the ring gear 22 at node R₁. In the 1^{st} forward gear, the input or drive member 12 rotates the sun gear 20 in one direction, for example, clockwise (CW), with the output at the ring gear 22 also in the clockwise direction (CW). At the same time, the first coupling assembly or mechanism 40 couples the planet carrier 28 to ground 36 and holds/fixes the planet carrier 28 stationary at node PC₁ against movement in one direction, for example, counterclockwise (CCW). Because the planet carrier 28 is stationary, torque input from the input or drive member 12 is transmitted through the sun gear 20, planet gears 24, 26, the ring gear 22, and ultimately, the output or driven member 14.

Lever diagram FIG. 2C shows the power transmission system or drive assembly 10 output at the output or driven member 14 when the drive assembly 10 is in 1^{st} reverse gear. The lever diagram of FIG. 2C shows the input moving one end of the lever 48 to the left, based on the input of the sun gear 20 at node S₁ with the lever 48 pivoting about the planet carrier 28 at node PC₁ and the output generated at the ring gear 22 at node R₁. In the 1^{st} reverse gear, the input or drive member 12 rotates the sun gear 20 in one direction, for example, counterclockwise (CCW), with the output at the ring gear 22 also in the counterclockwise direction (CCW). At the same time, the second, selectable or controllable one-way clutch of the first coupling assembly or mechanism 40 couples the planet carrier 28 to ground 36 and holds/fixes the planet carrier 28 stationary at node PC₁ against movement in one direction, for example, clockwise (CW). Because the planet carrier 28 is stationary, torque input from the input or drive member 12 is transmitted through the sun gear 20, planet gears 24, 26, the ring gear 22, and ultimately, the output or driven member 14—the lever 48 of FIG. 2C illustrates reverse movement wherein the input and output are reversed. Counterclockwise rotation of the input or drive member 12 correspondingly rotates the output or driven member 14 counterclockwise, providing a “reverse” motion or output, for example, when operating or moving a vehicle in reverse.

Lever diagram FIG. 2B shows the power transmission system or drive assembly 10 output at the output or driven member 14 when the drive assembly 10 is in a 2^{nd} forward gear. In 2^{nd} forward gear, the first one-way clutch of the second coupling assembly or mechanism 42 connects/couples the planet carrier 28 to the ring gear 22, wherein the sun gear 20, the ring gear 22, and planet carrier 28 rotate together in the clockwise direction, with the output or driven member 14 connected to the ring gear 22. The lever diagram shows the input moving the lever 48 to the right of the Y-axis, based on the input of the sun gear 20 at node S₁ with the output generated at the ring gear 22 at node R₁. FIG. 2B shows the planet carrier 28 rotating at the same speed as the sun gear 20 in the clockwise direction. The planet carrier 28 freely rotates or overruns the passive, first one-way clutch of the first coupling assembly or mechanism 40 in the clockwise (CW) direction because the first one-way clutch of the first coupling assembly or mechanism 40 passively disconnects/decouples the planet carrier 28 from ground 36 in the clockwise direction.

Lever diagram 2D shows the power transmission system or drive assembly 10 when shifting gears, for example, moving from 1^{st} forward gear to 2^{nd} forward gear—transitioning from lever diagram FIG. 2A to lever diagram FIG. 2B. The position of the lever 48 shows the 1^{st} forward gear prior to the shift with the input from the sun gear 20 shown at input point 47 and the output at the ring gear 22 shown at output point 49 with the one-way clutch of the first coupling assembly or mechanism 40 preventing counterclockwise rotation of the planet carrier 28 shown at point 45.

When the vehicle starts from first gear, but prior to shifting to second, the first coupling assembly or mechanism 40 needs to be placed in a proper state to allow the transmission to smoothly shift to second gear. The locking elements that prevent motion of the coupling assembly or mechanism 40 in the clockwise direction must be actively disengaged, for example, the locking elements or struts of the second one-way clutch associated with 1^{st} reverse gear and 1^{st} gear regeneration. If disengagement does not occur, the transmission will be unable to execute an upshift.

During the shift from 1^{st} forward gear to 2^{nd} forward gear the input motor speed is dropped, the input at sun gear 20 decreases, arrow 43. The output or driven member 14, connected to the ring gear 22, is connected to a wheel end of the vehicle. During shifting, the output of the ring gear 22 remains relatively constant with the speed and direction of the planet carrier 28 changing based on the input speed, the speed of the sun gear 20. As the speed of the sun gear 20 decreases, moves in the direction of the arrow 43, the planet carrier 28 begins to rotate in the clockwise (CW) direction and passively overrun the one-way clutch of the first coupling assembly or mechanism 40 in the clockwise direction. FIG. 2D shows the initial position 48a of the lever 48 prior to the shift occurring. as the speed of the sun gear 20 decreases, the lever 48 pivots about the output point 49, with the top or upper end of the lever 48 moving to position 48b, to the right of node PC₁, wherein the speed of the sun gear 20 and the speed of the planet carrier 28 are equal. Continued reduction in the speed of the sun gear 20 continues to pivot the lever 48 until it reaches the lever position 48c, wherein the planet carrier 28 is rotating faster in the clockwise direction than the ring gear 22. The difference in rotational speed is shown by the space or gap 41 at the upper ends of the lever 48, shown in lever positions 48b and 48c. The speed or angular velocity of the planet carrier 28 now exceeds that of the ring gear 22. Once the speed of the planet carrier 28 exceeds that of the ring gear 22 and is slightly positive, as shown by the gap 41, the selectable or controllable one-way clutch of the second coupling assembly or mechanism 42 actuates to actively deploy a locking element or strut. The deployed locking element or strut is in a passive condition, wherein the deployed locking element or strut overruns the planet carrier 28. As the motor speed and corresponding sun gear 20 speed increases, the lever 48 moves back toward the position shown in 48b wherein the deployed locking element or strut engages, coupling the planet carrier 28 and ring gear 22 and correspondingly driving the ring gear 22 at the same angular velocity as the planet carrier 28, which is driven by the sun gear 20 and corresponding input or drive member 12. There will be a slight delay in 2^{nd} forward gear torque transmittal until the overrunning speed of the second coupling assembly or mechanism 42 reaches zero, wherein the locking element of the second coupling assembly or mechanism passively engages and reacts torque. Continued increase in the input speed, sun gear 20 speed, moves the lever 48 to the right to lever position 48d.

Shifting from the 2^{nd} forward gear to the 1^{st} forward gear reverses the process of shifting from the 1^{st} forward gear to the 2^{nd} forward gear.

The second coupling assembly or mechanism 42 may be placed at other locations. Other examples include slowing the rotational speed or angular velocity of the sun gear 20 to below that of the ring gear 22, with the second coupling assembly or mechanism 42 placed between the sun gear 20 and the ring gear 22. The second coupling assembly or mechanism 42 engages, coupling the sun gear 20 with the ring gear 22 and driving the ring gear 22 at the same speed as the sun gear 20 wherein the rotational speed of the output or driven member 14 is the same as that of input or drive member 12. A further example includes the second coupling assembly or mechanism 42 acting between and coupling the sun gear 20 and the planet carrier 28.

In another example, the second coupling assembly or mechanism 42 includes a second, selectable or active one-way clutch. Similar to 1^{st} reverse gear, in 2^{nd} reverse gear, where reverse torque is reacted at the second coupling assembly or mechanism 42 but in the opposite direction as in 2^{nd} forward gear. Thus, the second coupling assembly or mechanism 42 allows motion of the planet carrier 28 in the counterclockwise direction. The second selectable or active one-way clutch of the second coupling assembly or mechanism 42 provides a 2^{nd} reverse gear. It also provides reaction torque during a regenerative braking condition in 2^{nd} gear, thus enabling energy transfer from the vehicle back through the transmission into the motor, now operating as a generator, and on into the battery.

The resulting analogous lever indicates that the second coupling assembly or mechanism 42 must be able to rotate freely (freewheel) in both its clockwise and counterclockwise directions while at other times react torque in either of both directions. Therefore, both locking element sets must be actively controlled, providing a disengaged or nondeployed mode and an engaged or deployed passive mode.

Typically, a vehicle is accelerated from zero or low speed in 1^{st} gear before shifting to 2^{nd} gear. In some situations, the vehicle may start directly from 2^{nd} gear. This architecture enables that capability.

While in 2^{nd} gear, once the first locking element of the second coupling assembly or mechanism 42 is deployed, the second element may be deployed or left nondeployed. Deploying the second element of the second coupling assembly or mechanism 42 provides regenerative braking in 2^{nd} gear. Leaving the second locking element in a nondeployed position provides a “coasting” condition. In a coasting condition, the motor is not driving, but the vehicle is free to continue moving down the road under inertial power. Coasting in 1^{st} gear can also be provided by keeping the second set of locking elements in a nondeployed position as well. There is no coasting condition in reverse. Coasting is different from regenerative braking, which slows a moving vehicle driving an electric motor in reverse to recapture energy.

Starting directly from 2^{nd} gear can be accomplished by ensuring that both sets of locking elements of the first coupling assembly or mechanism 40 are nondeployed; they are off. Next, one or both sets of elements of the second coupling assembly or mechanism 42 are deployed to provide reaction torque so that input torque can be delivered to the output. Additionally, when the vehicle is stationary, the locking element of the first and of the second coupling assembly or mechanism 40, 42 are deployed, either 3 or 4 sets. This provides a park lock feature, as the output shaft cannot rotate.

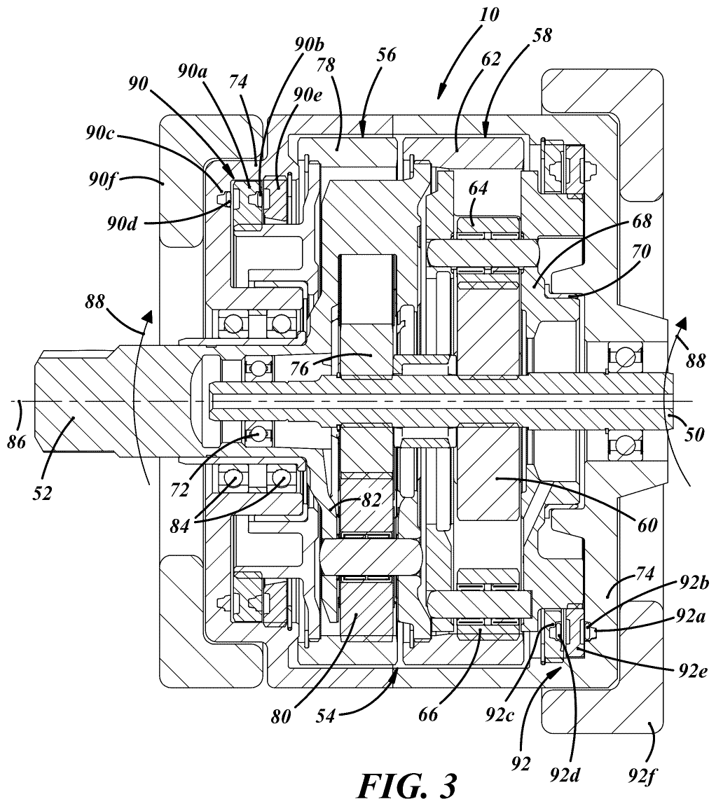

FIG. 3 schematically illustrates another example or embodiment of a gearset used with the power transmission system or drive assembly 10, including an electric motor (not shown) directly or indirectly driving an input or drive member 50 and an output or driven member 52. The power transmission system or drive assembly 10 includes a gear system or gear set, seen generally at 54, having two individual epicyclic gearsets, stages, or planetary gearsets 56, 58. The first stage or first planetary gearset 56 is a simple planetary gearset. It accomplishes a particular gear reduction, perhaps about 4:1. The second stage or second planetary gearset 58 is a compound “star” epicyclic set. It accomplishes a gear reduction of approximately half that of the first stage or first planetary gearset 56, or about 2:1.

The first stage or first planetary gearset 56 includes a sun gear 76, a ring gear 78, and a plurality of planet gears 80 meshed between the sun gear 76 and the ring gear 78. The sun gear 76 connects to and rotates with the input or drive member 50. The planet carrier 82 holds the planet gears 80 equidistantly from the centerline or axis of rotation 86 of the sun gear 76 and input or drive member 50.

The second stage or second planetary gearset 58 includes a sun gear 60, a ring gear 62, and a plurality of meshed inner and outer planet gears 64, 66 between the sun gear 60 and the ring gear 62. The sun gear 60 connects to and rotates with the input or drive member 50. The planet carrier 68 holds the inner and outer planet gears 64, 66 equidistant from the centerline or axis of rotation 86 of the sun gear 60 and input or drive member 50. Each set is equidistant but at different radii from the sun and ring gear while allowing the individual inner and outer planet gears 64, 66 to rotate with respect to each other. The inner planet gear 64 meshes with the sun gear 60, and the outer planet gear 66 meshes with the ring gear 62. Because the second stage or second planetary gearset 58 contains inner and outer planet gears 64, 66, it reverses the relative rotation direction of the ring gear 62 with respect to the sun gear 60, wherein the ring gear 62 rotates in the same direction as the sun gear 60.

The planet carrier 68 is rotatably supported on a stationary component or ground 74 by a bearing or bushing 70 and, wherein the planet carrier 68 rotates independently of the input or drive member 50 and the sun gear 60. A bearing 72 rotatably supports the ring gear 62 of the second planetary gearset 58 on the input or drive member 50, wherein the ring gear 62 rotates independently of the input or drive member 50 and the sun gear 60. A bearing 84 rotatably supports the ring gear 78 of the first planetary gearset 56 on the output or driven member 52, wherein the ring gear 78 rotates independently of the output or driven member 52.

The ring gear 62 of the second planetary gearset 58 connects to the planet carrier 82 of the first planetary gearset 56. The planet carrier 82 of the first planetary gearset 56 connects to and transfers torque to the output or driven member 52. Connecting the ring gear 62 of the second planetary gearset 58 to the planet carrier 82 of the first planetary gearset 56 provides a single mechanical path for both outputs from both planetary gearsets 56, 58.

As illustrated in FIG. 3, the output or driven member 52 connects to the planet carrier 82 of the first planetary gearset 56, with the output or driven member 52 rotating in the same direction as the input or drive member 50, shown by arrow 88. The power transmission system or drive assembly 10 includes a first coupling assembly or mechanism, generally seen at 90, and a second coupling assembly or mechanism, generally seen at 92.

In one example, the first coupling assembly or mechanism 90 includes first and second one-way clutches, each operable to engage/disengage and connect/disconnect the first ring gear 78 and ground 74 each working in opposite directions of rotation. The first coupling assembly 90 includes a combination pocket and notch plate 90a having a locking element 90b, a pocket plate 90c having a locking element 90d and a notch plate 90e. The combination pocket and notch plate 90a connected to the ring gear 78, with both the pocket plate 90c and notch plate 90e connected to ground 74. The first coupling assembly 90 includes an actuator and/or selector mechanism, seen generally at 90f. The actuator or selector mechanism could be operative, or used to control, the deployment of one or both of the locking elements 90b, 90d.

One clutch controls torque transfer in the first direction, for example, clockwise, and the other controls torque transfer in the second direction, counterclockwise. Using two one-way clutches provides both forward and reverse torque, providing power to a vehicle wheel assembly to move a vehicle in both forward and reverse.

In one example, the first one-way clutch of the first coupling assembly or mechanism 90 is a passive one-way clutch, and the second one-way clutch is a selectable or controllable one-way clutch. Each one-way clutch acts on the first ring gear 78 to control a power path-torque transfer from the input or drive member 50 to the output or driven member 52. The first or passive one-way clutch is always deployed, wherein torque is always transferred from the input or drive member 50 to the output or driven member 52 when the input or drive member 50 rotates in a first direction, for example, clockwise. The second or selectable or controllable one-way clutch is selectively deployed to transfer torque from the input or drive member 50 to the output or driven member 52 when the input or drive member 50 rotates in the second direction, for example, counterclockwise.

The passive one-way clutch of the first coupling assembly or mechanism 90 creates a connection between adjacent components, for example, the ring gear 78 and ground 74 wherein the ring gear locks in one direction and overruns when the ring gear 78 rotates in the opposite direction. The coupling assembly or mechanism 90 reacts torque in one direction, couples the ring gear 78 to ground 74, and overruns in the opposite direction, allows the ring gear 78 to rotate freely with respect to ground 74. The overrun state passively disconnects the ring gear 78 and ground 74, wherein the ring gear 78 rotates freely. The coupling assembly or mechanism 90 passively controls an operating mode of the power transmission system or drive assembly 10, wherein in a passive operating mode, the ring gear 78 is coupled to the stationary member or ground 74 in one direction and rotates freely with respect to the stationary member or ground 74 in the other. Passive engagement of the system allows power to be sent through the system in one direction, for example, to drive a vehicle wheel in a forward direction, without the need for one-way clutch controls such as selectors or actuation mechanisms.

The second one-way clutch of the first coupling assembly or mechanism 90 is a selectable or controllable one-way clutch movable from a nondeployed to a deployed position. When deployed, the second one-way clutch of the coupling assembly or mechanism 90 reacts torque in the opposite or second direction of rotation, couples the ring gear 78 to ground 74, preventing rotation in the opposite or second direction. The coupling assembly or mechanism 90 actively controls an operating mode of the power transmission system or drive assembly 10, wherein in an operating mode, the ring gear 78 is coupled to the stationary member or ground 74 in the opposite direction of rotation, for example, counterclockwise. Activating or engaging the second, selectable or controllable one-way clutch of the coupling assembly or mechanism 90 of the drive assembly 10 allows power to be sent through the system in the opposite direction, for example, a 1^{st} reverse gear, to drive a vehicle wheel in a reverse direction.

While the coupling assembly or mechanism 90 includes two one-way clutches, a first one-way clutch for forward motion and a second one-way clutch for reverse motion, the first one-way clutch of the coupling assembly or mechanism 90, typically associated with 1^{st} forward gear, can be passive, with the second one way-clutch being selectable or controllable. While the first one-way clutch is passive, it is contemplated that both the first and second one-way clutch can be selectable or controllable.

In addition to providing reverse gear or motion, the second one-way clutch of the coupling assembly or mechanism 90 can be used for regeneration in 1^{st} forward gear. The same one-way clutch that reacts torque during reverse also provides reaction torque during a regenerative braking condition in 1^{st} gear, thus enabling energy transfer from the vehicle back through the transmission into the motor, now a generator, and into the battery.

In the disclosed example, the coupling assembly or mechanism 90 includes a first or passive one-way clutch and a second or selectable or controllable one-way clutch. Each one-way clutch acts on the ring gear 78 contributing to a power path to transfer torque from the input or drive member 50 to the output or driven member 52. The passive one-way clutch is always deployed wherein torque is always transferred from the input or drive member 50 to the output or driven member 52 when the input or drive member 50 rotates in a first direction, for example, clockwise. The selectable or controllable one-way clutch is deployed to enable transfer of torque from the input or drive member 50 to the output or driven member 52 when the input or drive member 50 rotates in the second direction, for example, counterclockwise.

Because the first one-way clutch is passive, the first coupling assembly or mechanism 90 saves the attendant costs. It eliminates the need for an additional actuation system to control the first one-way clutch.

The second coupling assembly or mechanism 92 includes first and second one-way clutches. One clutch controls torque transfer in a first direction, for example, clockwise, and the other controls torque transfer in a second direction, for example, counterclockwise. Using two one-way clutches provides both forward and reverse torque, providing power to a vehicle wheel assembly to move a vehicle in both forward and reverse. The second coupling assembly 92 includes a pocket plate 92a having a locking element 92b, a pocket plate 92c having a locking element 92d, and a notch plate 92e. Both of the pocket plates 92a, 92c connect to ground 74 and the notch plate 92e connects to the planet carrier 68. The second coupling assembly 92 includes an actuator and/or selector mechanism, seen generally at 92f. The selector mechanism is operative to control the deployment of the one or both of the locking elements 92b, 92d.

In the disclosed example, both the first and second one-way clutches of the coupling assembly or mechanism 92 are selectable or controllable one-way clutches. Each one-way clutch acts on the second planet carrier 68 to control a power path-torque transfer from the input or drive member 50 to the output or driven member 52. When the first one-way clutch is deployed, torque is transferred from the input or drive member 50 to the output or driven member 52 when the input or drive member 50 rotates in a first direction, for example, clockwise. When the second one-way clutch is deployed, torque is transferred from the input or drive member 50 to the output or driven member 52 when the input or drive member 50 rotates in the second direction, for example, counterclockwise.

The first selectable or controllable one-way clutch of the second coupling assembly or mechanism 92 connects adjacent components, for example, the planet carrier 68 and ground 74, when the planet carrier 68 locks in one direction and overruns when the planet carrier 68 rotates in the opposite direction. When deployed, the first selectable or controllable one-way clutch of the coupling assembly or mechanism, 92 reacts torque in one direction, couples the planet carrier 68 to ground 74 preventing rotation, and overruns in the opposite direction, allows the planet carrier 68 to rotate freely with respect to ground 74. The overrun state passively disconnects the planet carrier 68 and ground 74 in one direction, wherein the planet carrier 68 rotates freely. The first selectable or controllable one-way clutch of the coupling assembly or mechanism 92 controls an operating mode of the power transmission system or drive assembly 10, wherein in a passive operating mode, the planet carrier 68 is coupled to the stationary member or ground 74 in one direction and freewheels with respect to the stationary member or ground 74 in the other.

The second one-way clutch of the coupling assembly or mechanism 92 also connects adjacent components, for example, the planet carrier 68 and ground 74 when the planet carrier 68 locks in one direction and overruns when the planet carrier 68 rotates in the opposite direction. When deployed, the second one-way clutch of the coupling assembly or mechanism 92 reacts torque in the opposite or second direction of rotation, couples the planet carrier 68 to ground 74, preventing rotation in the opposite or second direction. The overrun state passively disconnects the planet carrier 68 and ground 74 in one direction, wherein the planet carrier 68 rotates freely. The second selectable or controllable one-way clutch of the coupling assembly or mechanism 92 controls an operating mode of the power transmission system or drive assembly 10, wherein in a passive operating mode, the planet carrier 68 is coupled to the stationary member or ground 74 in the opposite direction of rotation. Activating or engaging the second selectable or controllable one-way clutch of the coupling assembly or mechanism 92 of the drive assembly 10 allows power to be sent through the system in the opposite direction, for example, a reverse direction.

In one example, the coupling assembly or mechanism 92 includes a first and second selectable or controllable one-way clutch. Each one-way clutch acts on the planet carrier 68 to contribute to a power path and transfer of torque from the input or drive member 50 to the output or driven member 52. The first or selectable or controllable one-way clutch transfers torque from the input or drive member 50 to the output or driven member 52 when the input or drive member 50 rotates in a first direction, for example, clockwise. The second selectable or controllable one-way clutch is deployed to transfer torque from the input or drive member 50 to the output or driven member 52 when the input or drive member 50 rotates in the second direction, for example, counterclockwise.

The first and second coupling assemblies or mechanisms 90, 92 cooperate to control gear ratios or drive output of the power transmission system or drive assembly 10. In one example, the power transmission system or drive assembly 10 is a 2-speed transmission having a 1^{st} gear and a 2^{nd} gear. For example, the first planetary gearset 56 provides a 1^{st} gear at about a 4:1 ratio, and the second planetary gearset 58 provides a 2^{nd} gear at about a 2:1 ratio. So, for example, this transmission has about a 2 to 1 step ratio.

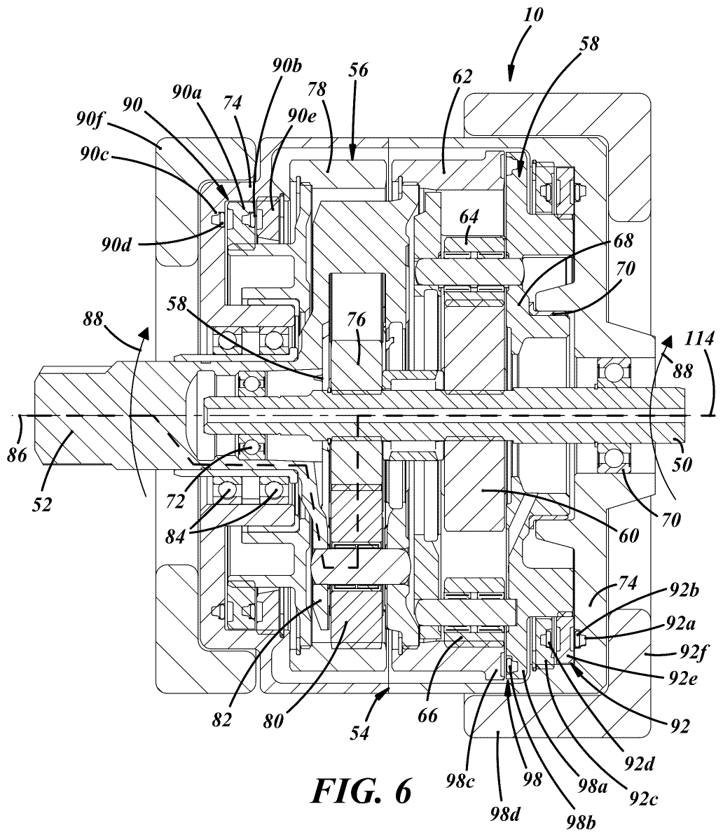

The power transmission system or drive assembly 10 operates in a 1^{st} gear when the ring gear 78 of the first planetary gearset 56 is coupled/connected to ground 74, wherein the ring gear 78 remains stationary and the planet carrier 68 of the second planetary gearset 58 is decoupled/disconnected from the ground 74, the planet carrier 68 is permitted to freewheel. The heavy dashed line 114 in FIG. 6 illustrates the power or torque path wherein the input or drive member 50 drives the output or driven member 52 through sun gear 76, planet gear 80, and planet carrier 82 combination at a ratio of about 4:1.

When operating the power transmission system or drive assembly 10 in 1^{st} gear, forward-associated, for example, with clockwise rotation, the direction of the arrow 88, of the input or drive member 50 and output or driven member 52, the first or passive one-way clutch of the first coupling assembly or mechanism 90 couples or connects the ring gear 78 of the first planetary gearset 56 to ground 74 preventing rotation in one direction, for example, counterclockwise, while allowing the first ring gear 78 to rotate in the opposite or clockwise direction. Ground 74, as used herein, is a stationary component, for example, a casing, housing, or other component that does not move relative to either the first or the second planetary gearsets 56, 58. In 1^{st} forward gear, both the first and second selectable or controllable one-way clutches of the second coupling assembly or mechanism 92 are nondeployed, with the planet carrier 68 of the second planetary gearset 58 decoupled/disconnected from ground 74, allowing the planet carrier 68 to rotate in the counterclockwise direction.

When operating the power transmission system or drive assembly 10 in 2^{nd} gear, forward-associated, for example, with clockwise rotation, the direction of the arrow 88, of the input or drive member 50 and output or driven member 52, the first or passive one-way clutch of the first coupling assembly or mechanism 90 passively decouples/disconnect the ring gear 78 of the first planetary gearset 56 from ground 74, allowing rotation in one direction, for example, clockwise. In 2^{nd} forward gear, at least one of the first and second selectable or controllable one-way clutches of the second coupling assembly or mechanism 92 is deployed, with the planet carrier 68 of the second planetary gearset 58 coupled/connected to ground 74 in the counterclockwise direction and free to move or overrun in the clockwise direction. The input or drive member 50 drives the output or driven member 52 through the sun gear 60, the inner and outer planet gears 64, 66, the ring gear 62, and the planet carrier 82 combination at a ratio of about 2:1.

In FIG. 3, the rotational direction of the input or drive member and the output or driven member rotation, shown by arrow 88, is the same. For example, if the input or drive member 50 rotates clockwise, then the output or driven member 52 also rotates clockwise. The first and second coupling assemblies or mechanisms 90, 92 include one-way clutches, controlling movement in one direction and overrunning in the other.

The first coupling assembly or mechanism 90 may include a passive, one-way clutch, such as a continuously deployed strut that passively prevents the counterclockwise rotation of the ring gear 78 while allowing the ring gear 78 to rotate freely in the clockwise direction. The second coupling assembly or mechanism 92 may include a selectable or controllable one-way clutch, for example, a deployable strut preventing counterclockwise rotation of the planet carrier 68 while allowing the planetary carrier 68 to rotate freely in the clockwise direction.

In another example, both the first and second coupling assemblies or mechanisms 90, 92 include selectable or controllable one-way clutches because the state of the clutch, activated or deactivated—the locking element or strut deployed or nondeployed, can be selected or controlled. Controlling the state of the clutch, activated or deactivated, controls whether the first and second coupling assemblies or mechanisms 90, 92 operate to couple/connect or decouple/disconnect various components. In one example, an activated clutch of the first coupling assembly or mechanism 90 may operate to couple the ring gear 78 of the first gearset to ground 74. In another example, a selectable or controllable one-way clutch of the second coupling assembly or mechanism 92 operates to couple the planet carrier 68 to ground 74. Like the forgoing example, coupling or decoupling portions of the gearset 54 with each other or to ground 74 helps to control the power transmission system or drive assembly output.

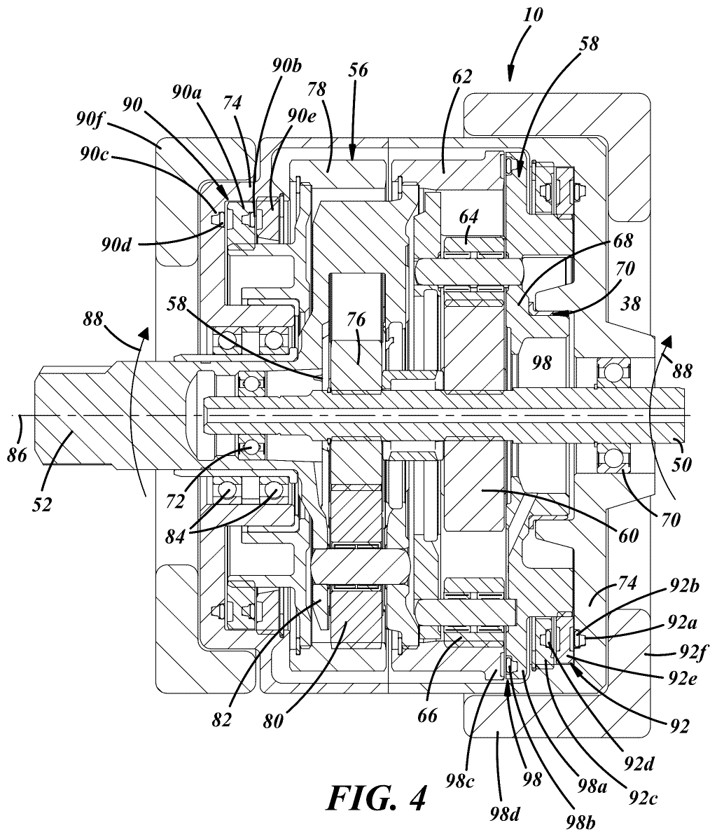

FIG. 4 shows another example, wherein the power transmission system or drive assembly 10 includes a 3^{rd} gear. The 3^{rd} gear can be accomplished by a third coupling assembly or mechanism 98 positioned in one of several locations. The 3^{rd} gear is a direct drive or 1:1 ratio wherein the input or drive member 50 and the output or driven member 52 are connected/fixed together. In one example, a three-speed transmission includes a third coupling assembly or mechanism 98, such as a dynamically controllable clutch (DCC) with two sets of locking elements similar to the previous coupling assemblies, as both races are rotating for any moving conditions for the vehicle.

FIG. 4 shows one example wherein the third coupling assembly 98 may couple/decouple or connect/disconnect the ring gear 62 with the planet carrier 68. The third coupling assembly 98 includes a pocket plate 98a having a locking element 98b and a notch plate 98c. The pocket plate 98a may be part of or connect to the planet carrier 68 and the notch plate 98c may be part or connect to the ring gear 62. The third coupling assembly 98 includes an actuator and/or selector mechanism, seen generally at 98d. The actuator or selector mechanism 98d is operative to control the deployment of the locking elements 98b. The third coupling assembly 98 may include first and second one-way clutches, enabling torque transfer in both directions of rotation. The first and second one-way clutches of the third coupling assembly 98 may be passive or selectable one-way clutches.

In other non-limiting examples, the third coupling assembly or mechanism 98 may couple/decouple or connect/disconnect the ring gear 78 with the planet carrier 82, the ring gear 78 with the ring gear 62, the sun gear 60 with the planet carrier 68, the sun gear 60 with the ring gear 62, the sun gear 76 with the ring gear 62, or the sun gear 76 with the planet carrier 82. Because the respective components are rotating relative to one another, the third coupling assembly or mechanism 98 is a clutch that couples/decouples two rotating components, for example, a dynamically controllable clutch. In each instance when the input or drive member 50 is connected/fixed to the output or driven member 52, both the first and second coupling assemblies or mechanisms 90, 92 disconnect/decouple their respective components from ground 74, wherein both the ring gear 78 and the planet carrier 68 freewheel with respect to ground. The coupling assemblies or mechanisms 90, 92, 98 may include actuation systems that control movement or engagement of the locking elements or struts associated with each coupling assembly or mechanism. Various actuation systems may be used, depending on whether both components rotate, or one is stationary and the other rotates. For example, linear motors, cam, lead screw, solenoid, and other force transmitting mechanisms. In one example, the actuation system acts on a force transmitting member that engages or contacts the locking element or strut. For example, selector plate, spring, pin, rod, etc. While the actuator or selector mechanism 98d is schematically shown as part of the actuator or selector mechanism 92f this is for illustration purposes only, each coupling assembly 90, 92, 98 may have its own actuator.

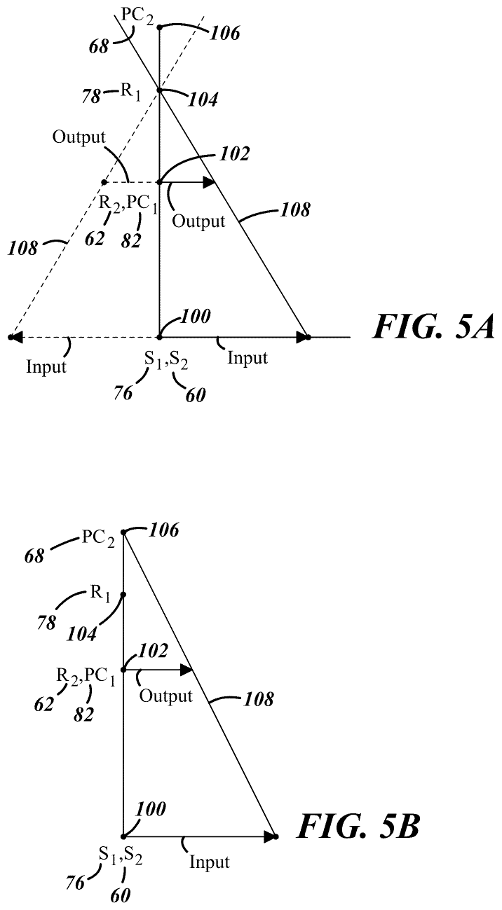

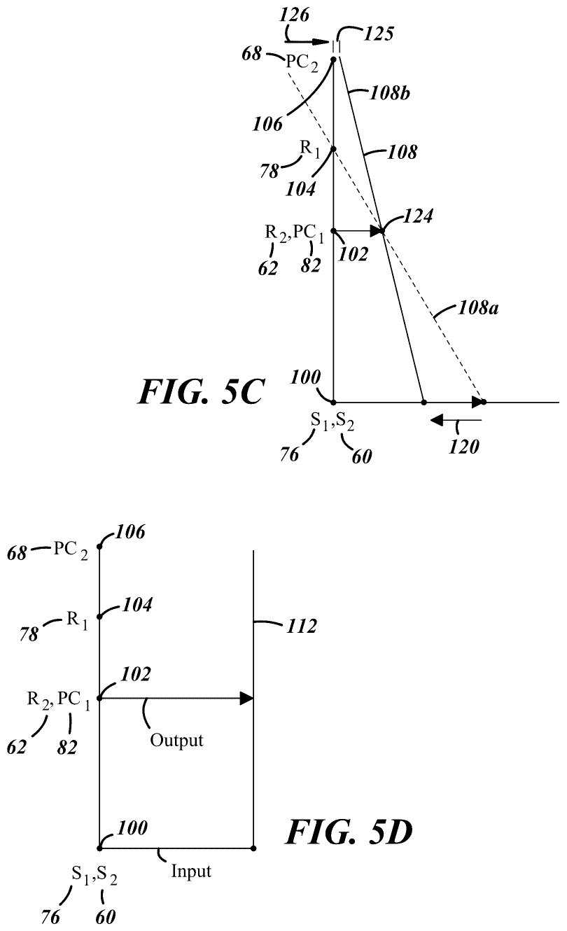

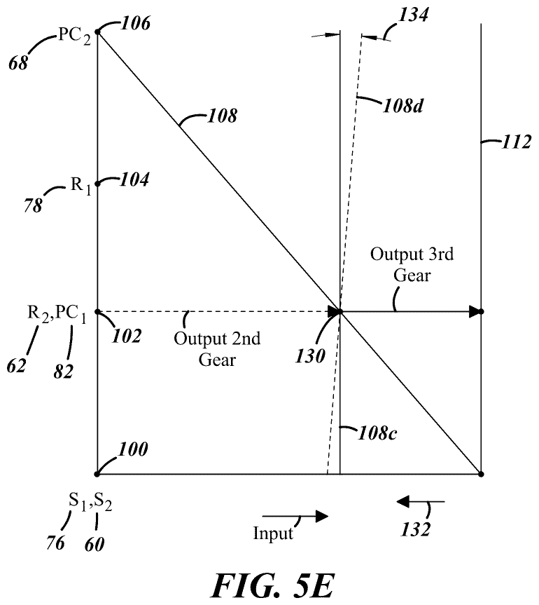

Lever diagrams, FIGS. 5A-5E, show the power transmission system or drive assembly 10 output at the output or driven member 52 in 1^{st}, 2^{nd}, and 3^{rd} gear.

The lever diagrams FIGS. 5A-5E are for the gearset 54 of FIGS. 3 and 4. The points or nodes 100, 102, 104, 106 of the lever are points of force or torque analogous to sun gears 76, 60, ring gear 62 and planet carrier 82, ring gear 78 and planet carrier 68. R₁, PC₁, and S₁ refer to the components of the first planetary gearset 56, and R2, PC2, and S2 refer to the components of the second planetary gearset 58.

FIG. 5A shows the power transmission system or drive assembly 10 having an input at the input node 100—sun gear 76 (S1) and sun gear 60 (S2) and an output at the output node 102—ring gear 62 (R2) and planet carrier 82 (PC1). In the disclosed example, motion on the X-axis, to the right of the Y-axis, is clockwise. While the motion on the X-axis, to the left of the Y-axis, is counterclockwise. When the transmission is in 1^{st} forward gear, the lever, illustrated by lever 108 of the lever diagram, is fixed at 1^{st} gear node 104—ring gear 78 (R1) and rotates freely at 2^{nd} gear node 106—planet carrier 68 (PC2). The passive strut of the first coupling assembly or mechanism 90 stops counterclockwise rotation and allows clockwise rotation of the ring gear 78 (R1). FIG. 5A shows the strut of the second coupling assembly or mechanism 92 is not deployed wherein the planet carrier 68 freely rotates in both directions, clockwise and counterclockwise; see the portion of the lever 108 above the 1^{st} gear node 104. The lever 108 moves with the input from the input node 100—sun gear 76 (S1) and sun gear 60 (S2), pivots about the 1^{st} gear node 104—ring gear 78 (R₁) with the output at the output node 102—ring gear 62 (R2) and planet carrier 82 (PC1). Because the planet carrier 68 rotates freely, it is not coupled at 2^{nd} gear node 106, the end of lever 108 moves to the left of the 2^{nd} gear node 106.

The dotted lever 108 of FIG. 5A illustrates reverse movement wherein the input and output directions are reversed. Counterclockwise rotation of the input or drive member 50 will correspondingly rotate the output or driven member 52 counterclockwise and provide a “reverse” motion or output, for example, when operating or moving a vehicle in reverse. While not shown in FIGS. 5B and 5D, dotted levers could be included to show reverse motion in 2^{nd} and 3^{rd} gear. Struts or locking members associated with each of the respective first, second, and third coupling assemblies or mechanisms 90, 92, 98 work in a similar manner when reversing the rotational direction of the input or drive member 50 to provide reverse motion. When the first, second, and third coupling assemblies or mechanisms 90, 92, 98 include two sets of struts, a first set for forward motion and a second set for reverse motion. In one example, the first set of struts of the first coupling assembly or mechanism 90, typically associated with 1^{st} forward gear, can be passive, with the second set of struts being selectable or controllable. While the first set of struts can be passive, it is contemplated that all sets of struts can be selectable or controllable. In addition to providing reverse gear or motion, the second set of struts for each of the first, second and third coupling assemblies or mechanisms 90, 92, 98 can be used for regeneration.

Lever diagram FIG. 5B shows the power transmission system or drive assembly 10 in a 2^{nd} forward gear. When the transmission is in 2^{nd} forward gear, the lever, illustrated by the lever 108 of the lever diagram, is fixed at the 2^{nd} gear node 106—planet carrier 68 (PC2) and rotates freely at the 1^{st} gear node 104—ring gear 78 (R1). The passive strut of the first coupling assembly or mechanism 90 stops counterclockwise rotation and allows clockwise rotation of the ring gear 78 (R1), and in 2^{nd} gear, is in an overrun state. The strut of the second coupling assembly or mechanism 92 is deployed and prevents counterclockwise rotation and allows clockwise rotation of the planet carrier 68 (PC2). The lever 108 moves with the input from the input node 100—sun gear 76 (S1) and sun gear 60 (S2), pivots about the 2^{nd} gear node 106—planet carrier 68 (PC2) with the output at the output node 102—ring gear 62 (R2) and planet carrier 82 (PC₁).

Lever diagram FIG. 5C shows the power transmission system or drive assembly 10 when shifting gears, for example, moving from 1^{st} forward gear to 2^{nd} forward gear—transitioning from lever diagram FIG. 5A to lever diagram FIG. 5B. The lever 108 is dashed to show the position 108a of the lever in the 1^{st} forward gear prior to the shift. To initiate the shift, the speed of the input or drive member 50 and correspondingly that of the sun gear 76 and sun gear 60 at the input node 100 is reduced as represented by the arrow 120. The output at the output node 102, ring gear 62 and planet carrier 82, remains relatively constant, as they are being driven by the vehicle wheel or other gear assembly component connected to the output or driven member 52. Because the rotational speed of the input or drive member 50 can be controlled relative to the rotational speed of the output or driven member 52, the lever 108 pivots about the output point 124. The passive strut of the first coupling assembly or mechanism 90 is in an overrun condition, allowing clockwise rotation of the ring gear 78 at first gear node 104. Because the first selectable or controllable one-way clutch of the second coupling assembly or mechanism 92, which stops rotation of the planet carrier 68 in the counterclockwise direction and overruns in the clockwise direction, is nondeployed the planet carrier freewheels in both directions. Slowing the rotational speed of the input or drive member 50 slows the counterclockwise rotation of the planet carrier 68 and moves the top or upper end of the lever 108 to the right, in the direction of the arrow 126, from the position 108a, towards and past the 2^{nd} gear node 106 to the position 108b, shown by solid lever 108. The difference in rotational speed is shown by the space or gap 125 between the upper end of the lever 108 at position 108b and the 2^{nd} gear node 106. The planet carrier 68 then begins to rotate clockwise. The first selectable or controllable one-way clutch of the second coupling assembly or mechanism 92 is then deployed, is in a passive condition, and overruns the planet carrier 68. Increasing the rotational speed of the input or drive member 50, causes the clockwise rotation of the planet carrier 68 to slow down. The top of the lever 108 moves to the left and approaches the 2^{nd} gear node 106. At or near the 2^{nd} gear node, the planet carrier 68 picks up the deployed strut, which prevents counterclockwise rotation of the planet carrier 68, wherein the transmission system or drive assembly 10 is in the 2^{nd} forward gear.

During the shift from first to second gear the input motor speed is dropped. As the motor speed begins to decrease, the first coupling assembly or mechanism 90 begins to passively overrun in a clockwise direction. Also, as the motor speed decreases, the freewheeling counterclockwise speed of second coupling assembly or mechanism 92 and planet carrier 68 decrease due to interaction of the second sun gear 60 relative to the speed of the second ring 62 which is connected to the output or driven member 52. The freewheeling speed of the second coupling assembly or mechanism 92 reverses direction as the rotation of the planet carrier 68 becomes slightly positive, rotates clockwise, as shown in FIG. 5C. Once the speed is slightly positive then the control system actively puts the correct locking elements into a passive condition. At this time, the motor will again begin to drive the transmission in 2^{nd} gear. There will be a slight delay in 2^{nd} gear torque transmittal until the overrunning speed of the second coupling assembly or mechanism 92 reaches zero and the element which prevents counterclockwise motion passively engages and react torque.

While still in the 2^{nd} forward gear, the second element of the second coupling assembly or mechanism 92 may be deployed or left disengaged once the first locking element is engaged. Engaging the second element of the second coupling assembly or mechanism 92 provides regenerative braking in second gear. Leaving the second locking element in a nondeployed position provides a “coasting” condition.

Shifting from the 2^{nd} forward gear to the 1^{st} forward gear simply reverses the process of shifting from 1^{st} to 2^{nd} gear. Coasting in 1^{st} gear can also be provided by keeping the second set of locking elements of the first coupling assembly or mechanism 90 nondeployed as well.

Lever diagram FIG. 5D shows the power transmission system or drive assembly 10 in 3^{rd} gear. A three-speed transmission includes a third coupling assembly or mechanism 98, for example, a dynamically controllable clutch (DCC) with two sets of locking elements similar to those of the first and second coupling assemblies or mechanisms 90, 92. But now, both races are rotating for any moving conditions for the vehicle. Shifting is accomplished in a similar manner to shifting from 1^{st} forward gear to 2^{nd} forward gear in that the first engaging set of locking elements will need to be actively placed into a passive condition and then loaded to transmit torque.

When the transmission is in a 3^{rd} gear, the lever, illustrated by the vertical lever 112 of the lever diagram, is free, not fixed at either the 1^{st} gear node 104—ring gear 78 (R₁) or the 2^{nd} gear node 106—planet carrier 68 (PC2) wherein both rotate freely. The vertical lever 112 moves with the input from the input node 100—sun gear 76 (S₁) and sun gear 60 (S2). The vertical lever 112 moves freely with respect to the 1^{st} gear node 104—ring gear 78 (R₁), and the 2^{nd} gear node 106—planet carrier 68 (PC2) and shows the output at the output node 102—ring gear 62 (R2) and planet carrier 82 (PC₁).

Lever diagram FIG. 5E shows the power transmission system or drive assembly 10 when shifting gears, for example, moving from 2^{nd} forward gear to 3^{rd} forward gear-transitioning from lever diagram FIG. 5B to lever diagram FIG. 5D. The lever 108 shows the position of the lever in the 2^{nd} forward gear prior to the shift with the input from the sun gears 60, 76 shown at input node 100 and the output at the ring gear 62 and planet carrier 82 shown at output point 130 with the one-way clutch of the second coupling assembly or mechanism 92 preventing counterclockwise rotation of the planet carrier 68 shown at 2^{nd} gear node 106.

During the shift from 2^{nd} forward gear to 3^{rd} forward gear the input motor speed is dropped, the input at input node 100 from the sun gears 76, 60 decreases, arrow 132. The output or driven member 52, connected to the ring 62 and planet carrier 82, is connected to a wheel end of the vehicle. During shifting, the angular velocity or speed at the output point 130 of the ring 62 and planet carrier 82 remains, relatively speaking, constant with the speed and direction of the planet carrier 68 changing based on the input speed, the speed of the sun gears 76, 60 at input node 100. As the speed of the sun gears 76, 60 decreases, moves in the direction of the arrow 132, the planet carrier 68 begins to rotate in the clockwise (CW) direction and passively overruns the one-way clutch of the first coupling assembly or mechanism 92 in the clockwise direction, the lever 108 moves to the right. FIG. 5E shows the lever 108 pivoting about the output point 130 as the speed of the sun gears 76, 60 decreases until reaching a position 108c, wherein they are equal to the speed of the planet carrier 68. Continued reduction in the speed of the sun gears 76, 60 moves the lever 108 until it reaches the position 108d, wherein the planet carrier 68 is rotating faster in the clockwise direction than the ring 62 and planet carrier 82. The difference in rotational speed is shown by the space or gap 134 at the upper end of the respective lever positions 108c and 108d. The speed of the planet carrier 68 now exceeds that of the ring gear 62 and planet carrier 82 in the clockwise direction. Once the speed of the planet carrier 68 exceeds that of the ring gear 62 and planet carrier 82 and is slightly positive, shown by the gap 134, the selectable or controllable one-way clutch of the third coupling assembly or mechanism 98 actuates to actively deploy the locking element or strut. The deployed locking element or strut is in a passive condition, wherein the deployed locking element or strut overruns the planet carrier 68. As the motor speed and corresponding sun gear 76, 60 speed increases, the lever 108 moves back to the position shown in 108c wherein the deployed locking element or strut engages, coupling the planet carrier 68 with the ring gear 62 and planet carrier 82, and correspondingly driving the ring gear 62 and planet carrier 82 at the same angular velocity as the planet carrier 68, which is driven by the sun gears 76, 60 and corresponding input or drive member 50. There will be a slight delay in 3^{rd} forward gear torque transmittal until the overrunning speed of the third coupling assembly or mechanism 98 reaches zero, and the locking element of the third coupling assembly or mechanism 98 prevents counterclockwise motion, passively engages, and reacts torque.

To shift from 3^{rd} forward gear to 2^{nd} forward gear, one reverses the process of shifting from 2^{nd} forward gear to 3^{rd} forward gear.

In 1^{st} gear, the first coupling assembly or mechanism 90 couples/connects the ring gear 78 to ground 74, wherein the first coupling assembly or mechanism 90 holds the ring gear 78 stationary, connects it to ground 74, and the second coupling assembly or mechanism 92 decouples/disconnects the planet carrier 68 from ground 74, wherein the planet carrier 68 freewheels with respect to ground 74. The heavy dashed line 114 in FIG. 6 illustrates the torque or power path from the input or drive member 50 through the gear system or gearset 54 to the output or driven member 52 in 1^{st} gear.

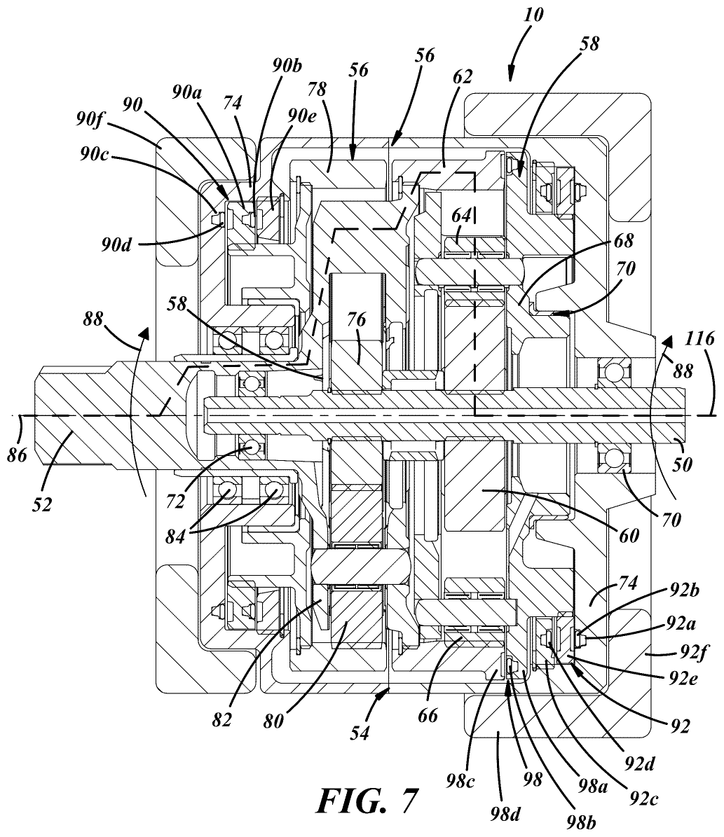

In 2^{nd} gear, the first coupling assembly or mechanism 90 decouples/disconnects the ring gear 78 from ground, wherein ring gear 78 freewheels with respect to ground 74. The second coupling assembly or mechanism 92 couples/connects the planet carrier 68 to ground 74, whereas the second coupling assembly or mechanism 92 connects the planet carrier 68 to ground 74 and holds it stationary. The heavy dashed line 116 in FIG. 7 illustrates the torque or power path from the input or drive member 50 through the gear system or gearset 54 to the output or driven member 52 in 2^{nd} gear.

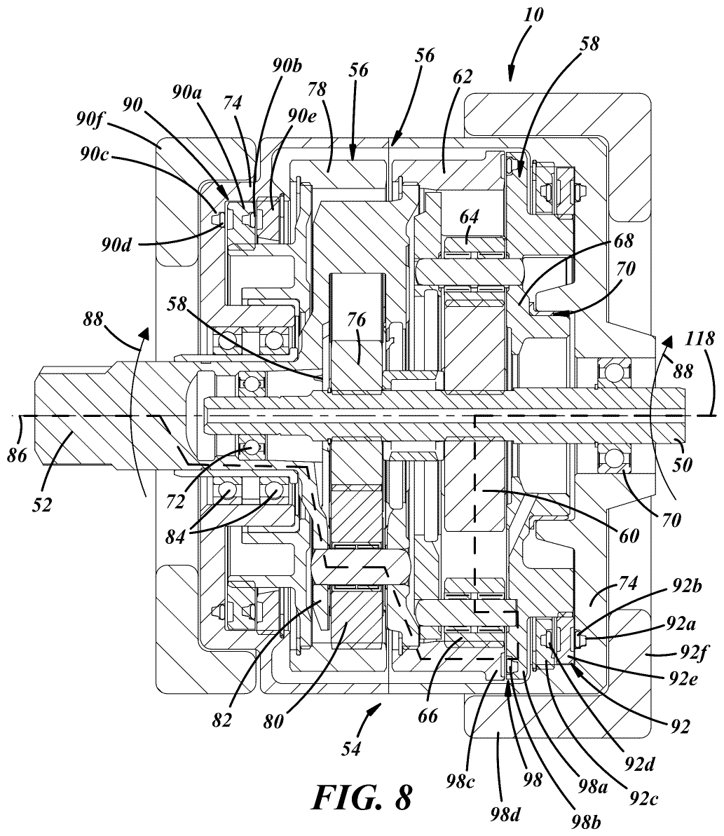

In 3^{rd} gear, the first coupling assembly or mechanism 90 decouples/disconnects the ring gear 78 from ground 74, wherein the ring gear 78 freewheels with respect to ground 74, and the second coupling assembly or mechanism 92 decouples/disconnects the planet carrier 68 from ground 74, wherein the planet carrier 68 freewheels with respect to ground 74. As shown in FIG. 8, the third coupling assembly or mechanism 98 may couple/decouple or connect/disconnect the ring gear 62 with the planet carrier 68. Doing so connects/fixes the input or drive member 50 and the output or driven member 52 together, wherein the input or drive member 50 and the output or driven member 52 rotate at the same speed. The heavy dashed line 118 in FIG. 8 illustrates the torque or power path from the input or drive member 50 through the gear system or gearset 54 to the output or driven member 52 in 3^{rd} gear.

The third coupling assembly or mechanism 98 may also couple or connect the first ring gear 62 and the second ring gear 78. Doing so connects/fixes the input or drive member 50 and the output or driven member 52 together, wherein the input or drive member 50 and the output or driven member 52 rotate at the same speed.

The third coupling assembly or mechanism 98 may also couple or connect the planet carrier 82 and the ring gear 78. Doing so connects/fixes the input or drive member 50 and the output or driven member 52 together, wherein the input or drive member 50 and the output or driven member 52 rotate at the same speed.

In addition, the third coupling assembly or mechanism 98 may connect the sun gear 60 with the ring gear 62, the sun gear 76 with the ring gear 62, or the sun gear 76 with the planet carrier 82. Each of these also connects/fixes the input or drive member 50 and the output or driven member 52 together, wherein the input or drive member 50 and the output or driven member 52 rotate at the same speed.

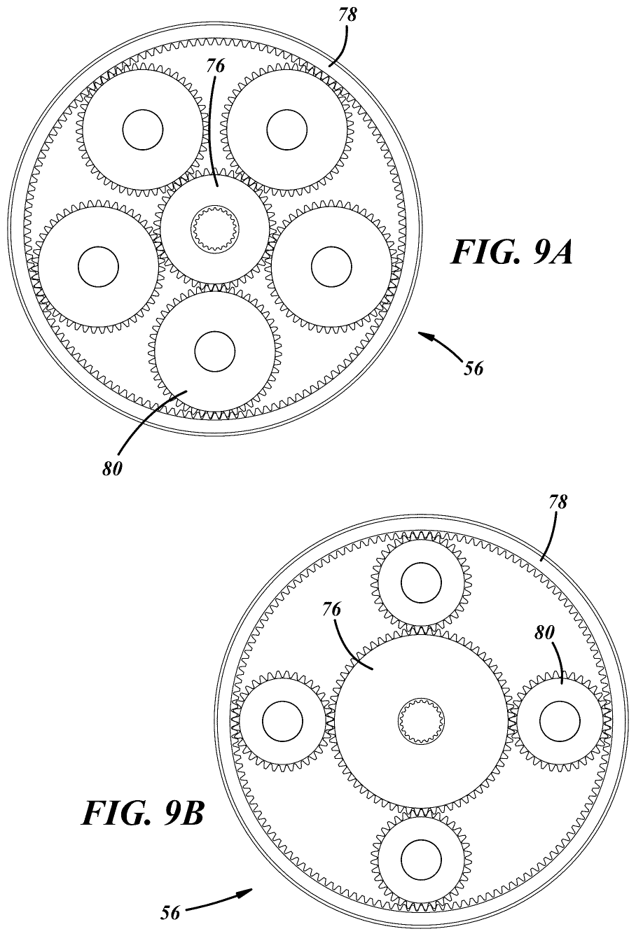

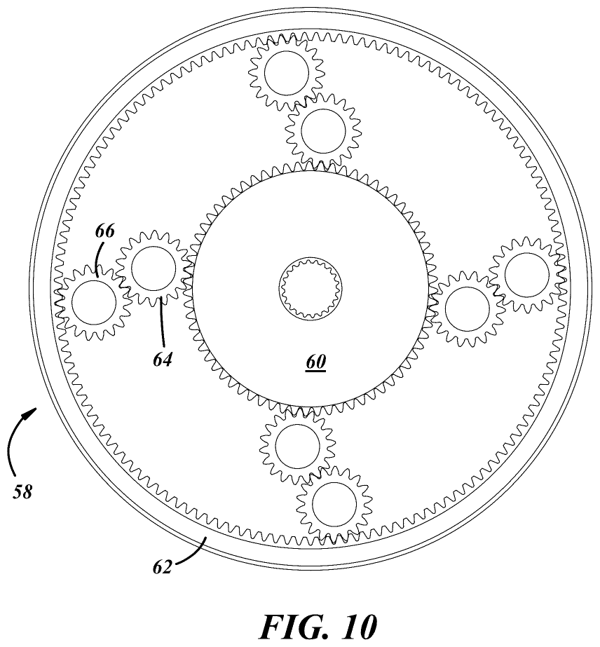

FIGS. 9A and 9B illustrate multiple examples of a first planetary gearset 56, including a sun gear 76, ring gear 78, and planet gears 80. Wherein the respective size and gear ratios vary. FIG. 10 illustrates an example of a second planetary gearset 58, including a sun gear 60, a ring gear 62, inner planet gears 64, and outer planet gears 66. Again, the respective size and gear ratios may vary.

Changes in the power transmission system or drive assembly output ratio may be accomplished by planetary gearsets, including a simple and compound planetary gearset. No change in motor direction is required, and the power transmission system or drive assembly substantially reduces, if not eliminates, “spool down” and “spool up” time when changing gears.

A brief overrun period between gears may be expected, but this period of time, or time lag occurring while changing gears, should be considerably less, preserving motor energy. Because the motor rotates in the same direction, there is no excess time lag while the coupling mechanisms connect and disconnect respective gearset components and change the gear ratios.

In one example, the power transmission system or drive assembly 10 requires one passive one-way clutch and two selectable or controllable one-way clutches. These clutches, along with the gear system or gearset, provide a two-speed system with reverse. An additional system includes a first coupling assembly or mechanism having a passive one-way clutch and a selectable or controllable one-way clutch and a second coupling assembly or mechanism having two selectable or controllable one-way clutches.

The foregoing are examples of the operational mode(s) of the power transmission or drive assembly 10. Additional operational modes, states, or transitions are available based on deployment or nondeployment, as well as engagement or nonengagement of the locking elements or struts. For example, regenerative braking and coasting are available.

While examples or exemplary embodiments are described above, it is not intended that these embodiments describe all possible forms of the present invention. The words used in the specification are words of description rather than limitation, and it is understood that various changes may be made without departing from the spirit and scope of the present invention. Additionally, the features of various implementing embodiments may be combined to form further embodiments of the present invention.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A power transmission system comprising:
a simple planetary gearset;
a compound planetary gearset;
a first coupling mechanism associated with the simple planetary gearset; and
a second coupling mechanism associated with the compound planetary gearset wherein the first coupling mechanism selectively couples a component of the simple planetary gearset to ground, and the second coupling mechanism selectively couples a component of the compound planetary gearset to ground.

2. The power transmission system of claim 1 wherein:
the simple planetary gearset includes a sun gear, a planet gear, a ring gear, and a planet carrier, wherein the planet gear, ring gear, and sun gear mesh;
the compound planetary gearset includes a sun gear, inner planet gears, outer planet gears, a ring gear, and a planet carrier supporting both the inner planet gears and the outer planet gears, wherein the sun gear and inner planet gears mesh, the ring gear and outer planet gears mesh, and the inner and outer planet gears mesh;
an input member connected to a sun gear of the simple planetary gearset; and
an output member connected to a planetary carrier of the compound planetary gearset.

3. The power transmission system of claim 1 wherein:
the first coupling mechanism includes a passive one-way clutch; and
the second coupling mechanism includes a selectable one-way clutch.

4. The power transmission system of claim 2 wherein:
the input member rotates in a first direction and a second direction;
the output member rotates in the first direction and the second direction; and
the output member rotates in the same direction as the input member.

5. The power transmission system of claim 4 wherein:
the first coupling mechanism includes a passive one-way clutch associated with the first direction of rotation and a selectable one-way clutch associated with the second direction of rotation; and
the second coupling mechanism includes a selectable one-way clutch associated with the first direction of rotation and a selectable one-way clutch associated with the second direction of rotation.

6. The power transmission system of claim 1 wherein:
the system operates in a first gear when the first coupling mechanism connects a ring gear of the simple planetary gearset to ground; and
the system operates in a second gear when the second coupling mechanism connects a planet carrier of the compound planetary gearset to ground.

7. The power transmission system of claim 2 wherein:
the ring gear of the compound planetary gearset is connected to the planet carrier of the simple planetary gearset and provides a single output path for both the compound planetary gearset and the simple planetary gearset.

8. The power transmission system of claim 2 wherein:
the first coupling mechanism couples the ring gear of the simple planetary gearset to ground; and
the second coupling mechanism couples the planet carrier of the compound planetary gearset to ground.

9. The power transmission system of claim 1 wherein:
the simple planetary gearset includes a plurality of rotatable components;
the compound planetary gearset includes a plurality of rotatable components; and
a third coupling mechanism acts between at least two of the rotatable components to connect an input member to an output member wherein the output member rotates at the same speed and in the same direction as the input member.

10. The power transmission system of claim 9 wherein:
the coupling mechanism connects the input member to the output member through at least one combination of components selected from the group consisting essentially of a ring gear of the simple planetary gearset with a planet carrier of the simple planetary gearset, the ring gear of the simple planetary gearset with a ring gear of the compound planetary gearset, the ring gear of the compound planetary gearset with a planet carrier the compound planetary gearset, a sun gear of the compound planetary gearset with the planet carrier the compound planetary gearset, the sun gear of the compound planetary gearset with the ring gear of the compound planetary gearset, a sun gear of the simple planetary gearset with the ring gear of the compound planetary gearset, or the sun gear of the simple planetary gearset with a planet carrier of the simple planetary gearset.

11. A transmission comprising:
an input member rotatable in a first direction and a second direction;
an output member rotatable in the first direction and the second direction;
a simple planetary gearset connected to the input member;
a compound planetary gearset connected to the input member;
a first coupling mechanism associated with the simple planetary gearset; and
a second coupling mechanism associated with the compound planetary gearset wherein the first coupling mechanism couples a component of the simple planetary gearset to ground, and the second coupling mechanism couples a component of the compound planetary gearset to ground wherein the output member always rotates in the same direction as the input member.

12. The transmission of claim 11 wherein:
the first coupling mechanism connects a ring gear of the simple planetary gearset to ground; and
the second coupling mechanism connects a planet carrier of the compound planetary gearset to ground.

13. The transmission of claim 11 wherein:
the first coupling mechanism includes a first one-way clutch associated with the first direction of rotation and a second one-way clutch associated with the second direction of rotation; and
the second coupling mechanism includes a first one-way clutch associated with the first direction of rotation and a second one-way clutch associated with the second direction of rotation.

14. The transmission of claim 11 wherein:
the first coupling mechanism includes a passive one-way clutch; and
the second coupling mechanism includes a selectable one-way clutch.

15. The transmission of claim 11 includes:
a third coupling mechanism that connects the input member to the output member wherein the output member rotates at the same speed and in the same direction as the input member.

16. A transmission comprising:
an input member rotatable in a first direction and a second direction;
an output member rotatable in the first direction and the second direction;
a compound planetary gearset including a plurality of rotating components, the compound planetary gearset connecting the input member to the output member;
a first coupling mechanism connects a component of the compound gearset to a stationary member wherein the output member rotates in the same direction as the input member; and
the second coupling mechanism connects at least two of the rotatable components to connect the input member to the output member wherein the output member rotates at the same speed and in the same direction as the input member.

17. The transmission of claim 16 wherein:
the first coupling mechanism includes a passive one-way clutch; and the second coupling mechanism includes a selectable one-way clutch.

18. The transmission of claim 16 wherein:
the first coupling mechanism includes a first one-way clutch associated with the first direction of rotation and a second one-way clutch associated with the second direction of rotation; and
the second coupling mechanism includes a first one-way clutch associated with the first direction of rotation and a second one-way clutch associated with the second direction of rotation.

19. The transmission of claim 16 wherein:
the first coupling mechanism includes a passive one-way clutch associated with the first direction of rotation and a selectable one-way clutch associated with the second direction of rotation; and
the second coupling mechanism includes a first selectable one-way clutch associated with the first direction of rotation and a second selectable one-way clutch associated with the second direction of rotation.

20. The transmission of claim 16 wherein:
the first coupling mechanism connects a planet carrier of the compound gearset to the stationary member; and
the second coupling member connects a planet carrier of the compound gearset to a ring gear of the compound planetary gearset.
